(19) United States
(12) Patent Application Publication
(10) Pub. No.: US 2006/0124394 A1
(43) Pub. Date: Jun. 15, 2006

(54) Ladder clamp

(76) Inventors: Vincent Joseph Christopher Bracken, Dublin (IE); Stephen May, Dublin (IE)

Correspondence Address: BIRCH STEWART KOLASCH & BIRCH, PO BOX 747, FALLS CHURCH, VA, 22040-0747, US

(21) Appl. No.: 10/555,206

(22) PCT Filed: May 4, 2004
(86) PCT No.: PCT/IE04/00065

§ 371 Date: Dec. 6, 2005

(30) Foreign Application Priority Data
May 1, 2003 (IE) S2003/0329

(51) Int. Cl. E06C 7/42

(52) U.S. Cl. 182/107

(57) ABSTRACT

A ladder clamp (1) comprises a securing clamp (3) for mounting fast on a ladder and a structure engaging clamp (5) connected to the securing clamp for securing the ladder clamp to a portion of a structure. The structure engaging clamp further comprises a substantially c-shaped bracket (7) and a driving rod (19) slidable within a bore on the c-shaped bracket. A driven ratchet mechanism (21) is located between the driving rod and the c-shaped bracket for urging the driving rod towards a fixed clamping head (15) mounted on the c-shaped bracket and there is additionally provided a quick release locking means (23) to release the driven ratchet mechanism. The ladder clamp may thus be connected and disconnected in a quick and secure manner.

### INTRODUCTION

The present invention relates to a ladder clamp comprising a securing clamp for mounting fast on a ladder and a structure engaging clamp connected to the securing clamp for securing the ladder clamp to a portion of a structure.

One of the main problems with ladders is their general instability. One of the most frequent causes of accidents involving ladders is caused by side slippage of the ladder. This side slippage is often caused by overreaching of an individual when they are up the ladder thereby causing the ladder to tilt to one side. It is known, for example, to provide struts and the like to support a ladder on the ground and indeed in many situations it is considered good practice to in some way bind the ladder to the structure against which it is resting. In order to bind the ladder to a structure, a rope or other similar item must be anchored to both the ladder and the structure. Typically though, the ladder will be resting against a window sill, parapet wall, gutter or other such type of structure and it is virtually impossible to securely fasten the ladder to any of these structures simply by tying the ladder to the structure.

Various devices have been proposed in order to overcome the difficulties with the known methods of securing the ladder to a structure. One such device is that described in GB610261 (Gilbert). This patent application describes a ladder clamp that may be used to prevent side slippage of a ladder when the ladder is resting against a gutter. The ladder clamp is first of all mounted onto a gutter by tightening a clamping screw to secure the ladder clamp to the gutter before an angularly bent rod connected to the ladder clamp is secured around a side of the ladder. The angularly bent rod is secured in place by adjusting a pair of hand nuts until the rod is in the desired position. A problem with this type of clamp is that a user must then tighten both the clamping screw and the pair of hand nuts in order to secure the ladder in position. This can be a relatively cumbersome and time consuming procedure which is undesirable particularly when the user of the device may be several feet above ground when attempting to fix the ladder clamp in position. Furthermore, a significant amount of time must be spent in order to release the ladder clamp from the gutter which could be spent on other activities.

Another known device is that described in GB137889 (Henson). This patent application describes a device that helps prevent sideways slippage of a ladder. A bracket is placed around one side of a ladder before the bracket is attached to a gutter or the like by a twist screw. There are however, problems with this type of clamp. First of all, by using a twist screw to fasten the clamp to the gutter the user will be limited in how tightly they can attach the clamp to the gutter and the speed in which the clamp may be connected and more particularly disconnected from the gutter will be limited. In addition to this the clamp will be relatively cumbersome to operate and is limited in the number of objects that it may be used to secure the ladder to.

It is an object therefore of the present invention to provide a ladder clamp that overcomes at least some of these difficulties that is both simple and efficient to operate. It is a further object of the present invention to provide a ladder clamp that is flexible in use that may be used to secure the ladder to a variety of different structures.

### STATEMENTS OF INVENTION

According to the invention there is provided a ladder clamp comprising a securing clamp for mounting fast on a ladder and a structure engaging clamp connected to the securing clamp for securing the ladder clamp to a portion of a structure characterised in that the structure engaging clamp comprises:
(a) a substantially c-shaped bracket having a body portion bridging a pair of outwardly projecting arms;
(b) a fixed clamping head mounted adjacent the free end of one of the arms and a movable clamping head mounted on a driving rod, the driving rod being slidable within a bore in the other arm for movement towards and away from the fixed clamping head; and
(c) a driven ratchet mechanism between the driving rod and the c-shaped bracket for urging the driving rod and hence the movable clamping head towards the fixed clamping head for engagement of a structure therebetween and a quick release locking means to allow disengagement of the ratchet and hence disengagement of the movable clamping head.

By having such a ladder clamp the ladder clamp may be secured to a portion of a structure in a matter of seconds. The driven ratchet mechanism will allow the user to tighten the clamp around the structure in a quick and efficient manner so that the user of the device will not have to spend time adjusting twist screws and the like. This is seen as highly advantageous. In addition to this, the user of the device will only need one hand in order to tighten the ladder clamp around the portion of the structure thereby allowing them to keep their other hand on the ladder which will help to prevent any accidents that may occur. Another advantage of the ladder clamp is that the driven ratchet mechanism may be released quickly in order to free the ladder clamp from the structure thereby facilitating the use of the device, particularly if the ladder is being moved frequently as the time saved by the user will be significant.

In another embodiment of the invention there is provided a ladder clamp in which the quick release locking means further comprises a locking plate having a through bore for reception of the driving rod, the locking plate being tiltable relative the driving rod to and from a locking configuration and a release configuration and a resilient biasing member for urging the locking plate into a locking configuration. This is seen as a particularly simple construction of quick release locking means that will be simple and cost efficient to manufacture. Furthermore, this type of locking means will allow the ladder clamp to be released from the portion of the structure in a very quick manner which will greatly facilitate the use of the device.

In one embodiment of the invention there is provided a ladder clamp in which the driven ratchet mechanism further comprises a driving plate having a through bore for reception of the driving rod, and a trigger pivotally mounted intermediate its ends on the structure engaging clamp, one end of the trigger being in engagement with the driving plate, the driving plate being tiltable to and from a driving configuration in which the driving plate grips the driving rod and causes the driving rod to move towards the fixed clamping head and a release configuration in which the driving plate is able to move relative the driving rod, the driving plate being tiltable on actuation of the trigger. Again, this is seen as a very simple construction of driven ratchet mechanism that will be simple and cost efficient to manufacture. In addition to this the mechanism can be easily operated by the user even when the user has only one hand available to operate the mechanism.

In a further embodiment of the invention there is provided a ladder clamp in which there is provided a resilient biasing member acting on the driving plate, urging the driving plate into a release configuration. By having the resilient biasing member acting on the driving plate, the biasing member will in turn act on the trigger which will be returned to a rest position ready for operation and further tightening of the clamp. This will facilitate the operation of the trigger and the ladder clamp.

In another embodiment of the invention there is provided a ladder clamp in which there are provided a pair of securing clamps connected to the structure engaging clamp, one of the securing clamps being located on one side of the structure engaging clamp and the other securing clamp being located on the other side of the structure engaging clamp. In this way the ladder clamp will be extremely flexible and the user, of the ladder clamp will be able to connect the ladder clamp on either side of the ladder. The user will not then be limited in the position that they must arrange the ladder and will be able to place the ladder clamp on either of the side portions of a ladder. This is seen as particularly useful.

In one embodiment of the invention there is provided a ladder clamp in which the securing clamp is rotatably mounted with respect to the structure engaging clamp. This is also seen as highly useful as the ladder clamp will be able to be secured to the ladder regardless of the orientation of the ladder with respect to the wall and regardless of the orientation of the portion of the structure to which the ladder clamp is to be secured. It is envisaged that this will also facilitate a good engagement between the ladder clamp and the ladder each time the ladder clamp is secured around the ladder.

In a further embodiment of the invention there is provided a ladder clamp in which the securing clamp further comprises a substantially U-shaped bracket having a locking member for securing the securing clamp to the ladder. This is seen as a good configuration of securing clamp as the securing clamp may be installed around the ladder in the shortest possible time while at the same time still permitting a good connection between the securing clamp and the ladder. It is envisaged that the locking member may comprise a twist screw for bearing against a side of the ladder. The twist screw will provide a secure connection between the securing clamp and the ladder. Alternatively, the locking member may comprise a strap connected at one end to the ladder clamp and its other end being securable in a strap fastener mounted on the securing clamp. In this way the strap could be fastened around the ladder in a quick and simple manner thereby securing the ladder clamp in position.

In another embodiment of the invention there is provided a ladder clamp in which the movable clamping head is pivotally mounted on the driving rod. In this way the ladder clamp will be flexible in use in that it may be attached to a variety of different shaped walls, window sills and other similar structures as the clamping head may pivot to match the orientation of the portion of structure to which it is being connected. This will enable the ladder clamp to provide a secure connection with practically any structure to which it is introduced. In addition to this, the fixed clamping head may also be pivotally mounted adjacent the free end of the arm. It is envisaged that the movable clamping head and the fixed clamping head may be mounted by way of a ball and socket joint or by way of a universal joint.

In one embodiment of the invention there is provided a ladder clamp in which the clamping heads are provided with a non-slip coating.

In a further embodiment of the invention there is provided a ladder clamp in which the clamping heads are substantially arcuate in cross-section, the open mouth of each of the clamping heads facing the open mouth of the other clamping head. In this way the ladder clamp may be used to secure the ladder clamp to scaffolding or piping and the like in a very secure fashion. Alternatively, the clamping heads may be substantially semi-circular in cross-section. Furthermore, at least one of the clamping heads could be substantially L-shaped in cross-section. This could facilitate the connection of the ladder clamp to angled sections.

In another embodiment of the invention there is provided a ladder clamp in which there is provided at least one stabilizing strut protruding outwardly from the C-shaped bracket in substantially the same direction as the securing clamp for engaging the outer face of the side of the ladder upon which the ladder clamp is mounted. By having such a strut the ladder clamp will be even further stabilized against sideways motion as the strut will also act on the side of the ladder thereby spreading the load between the strut and the securing clamp.

### DETAILED DESCRIPTION OF THE INVENTION

The invention will now be more clearly understood from the following description of some embodiments thereof given by way of example only with reference to the accompanying drawings in which:—

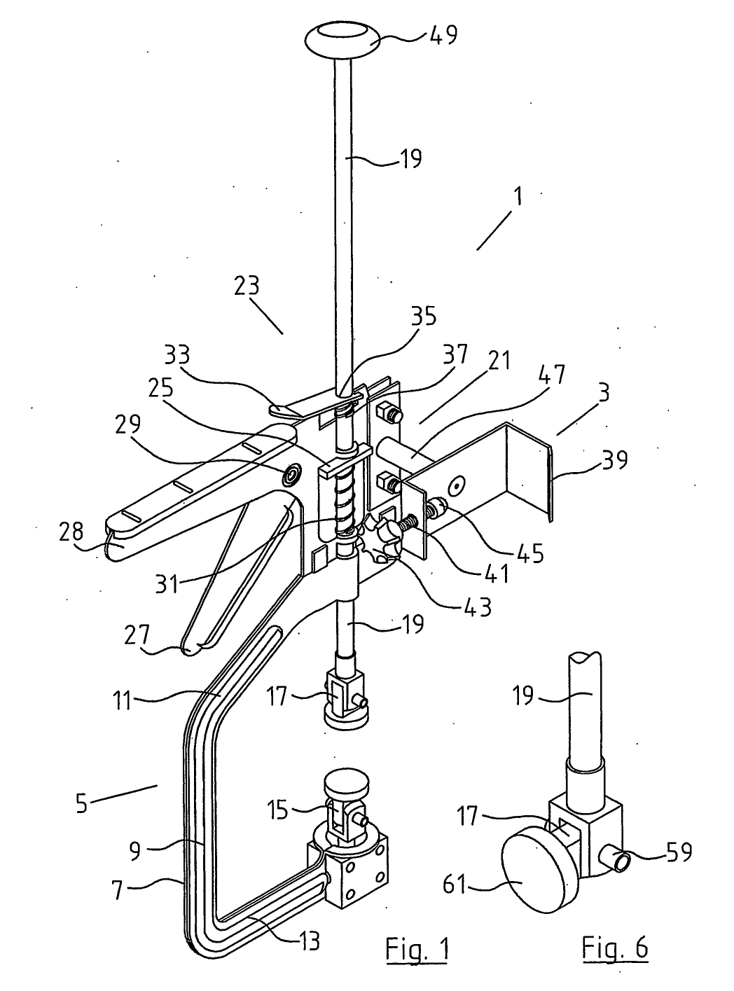

FIG. 1 is a rear perspective view of a ladder clamp according to the present invention;

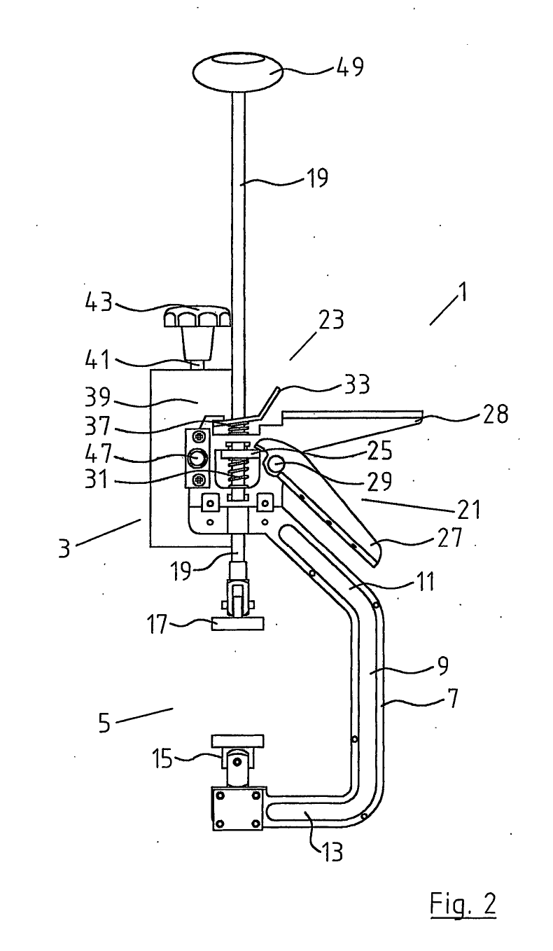

FIG. 2 is a left hand side view of the ladder clamp shown in FIG. 1;

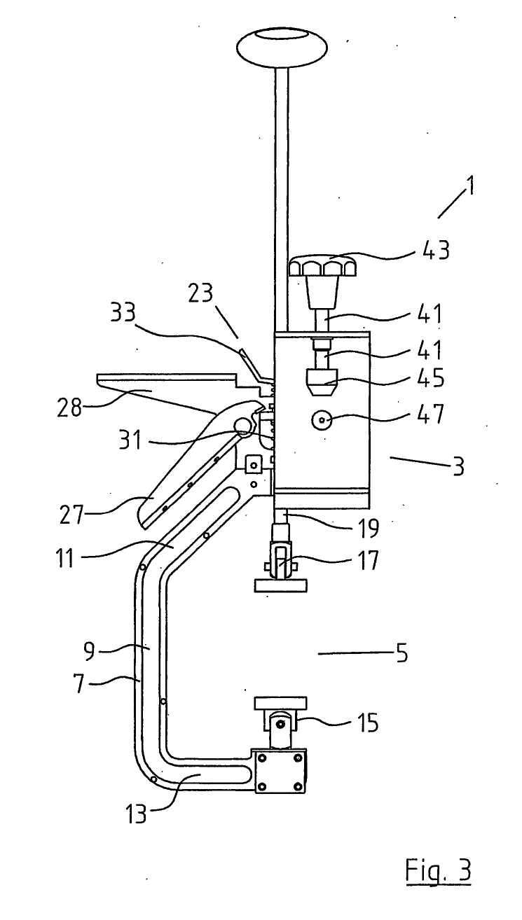

FIG. 3 is a right hand side view of the ladder clamp shown in FIG. 1;

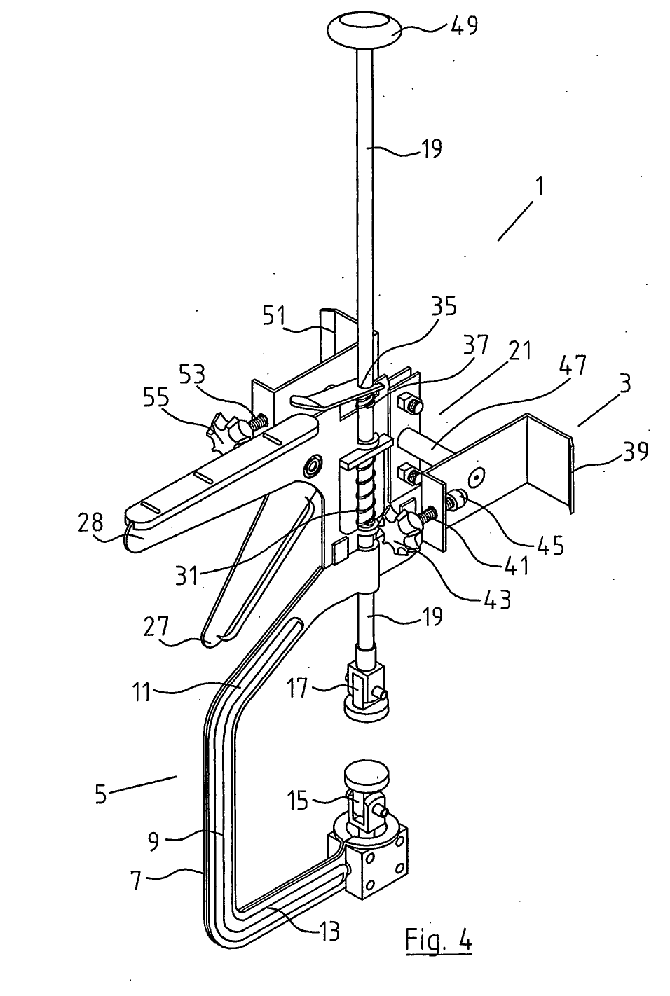

FIG. 4 is a rear perspective view of an alternative construction of ladder clamp according to the invention;

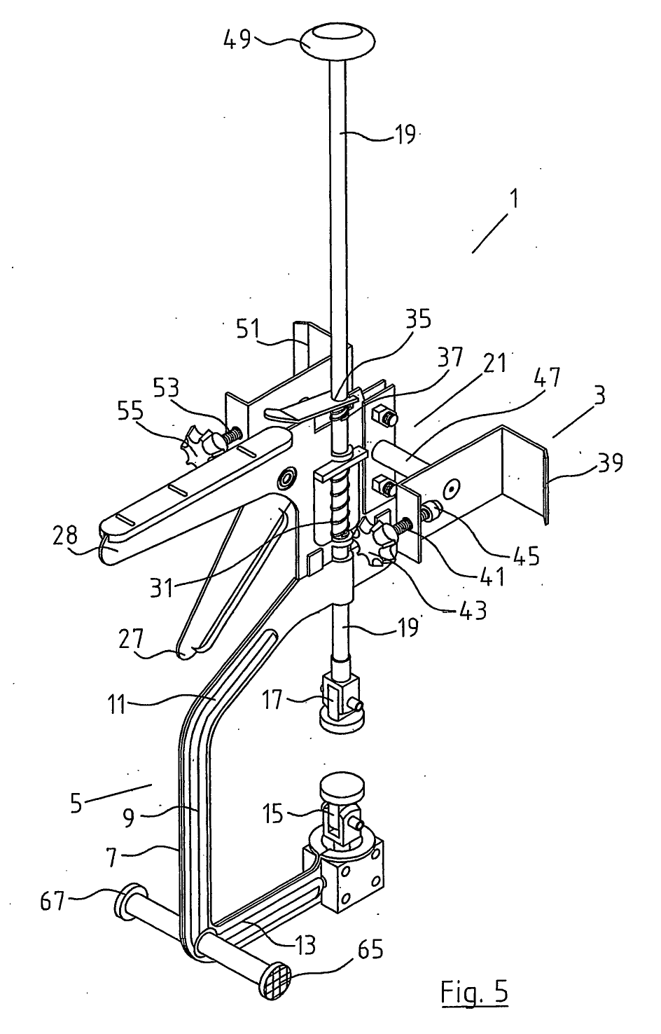

FIG. 5 is a rear perspective view of another alternative construction of ladder clamp according to the invention;

FIG. 6 is an enlarged view of the movable clamping head used with the ladder clamp according to the invention;

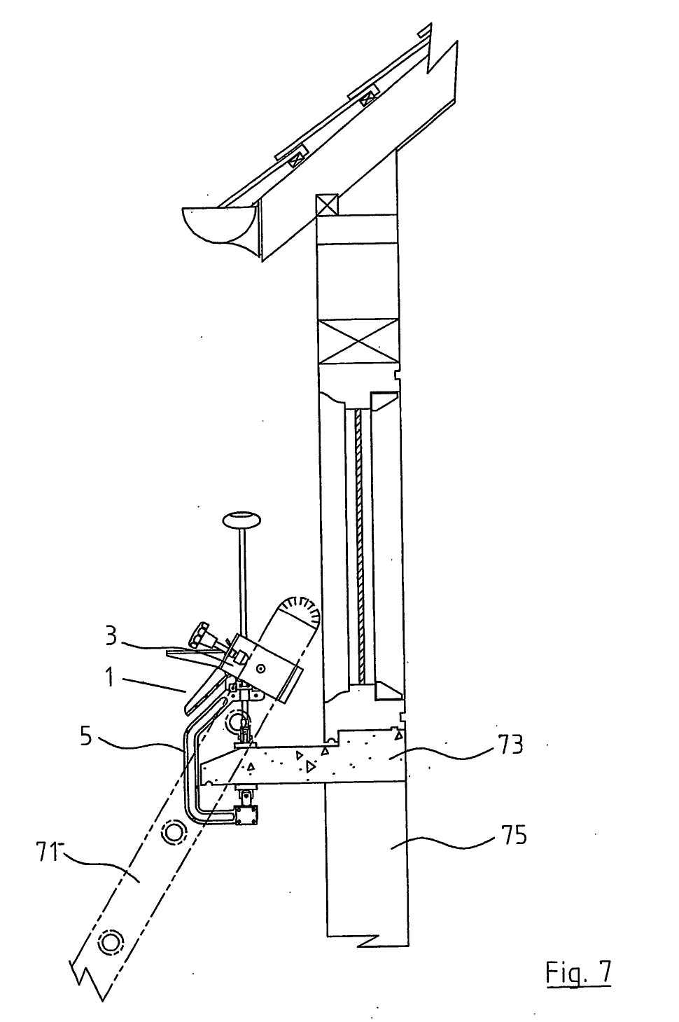

FIG. 7 is a right hand side view of a ladder clamp according to the invention in use with the ladder clamp secured to a ladder and a window sill, the ladder being shown in ghost; and

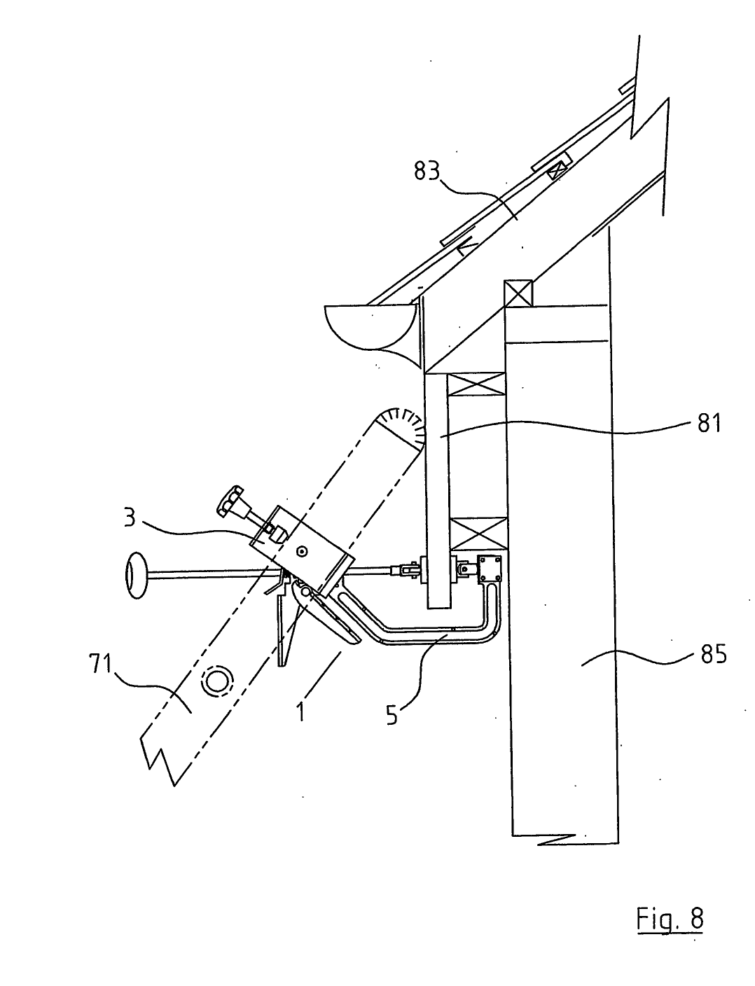

FIG. 8 is a right hand side view of a ladder clamp according to the invention in use with the ladder clamp secured to a ladder and a fascia board, the ladder being shown in ghost.

Referring to the drawings and initially to FIGS. 1 to 3 thereof, there is shown a ladder clamp, indicated generally by the reference numeral 1, comprising a securing clamp 3 for mounting fast on a ladder (not shown), and a structure engaging clamp 5 connected to the securing clamp for securing the ladder to a portion of a structure. The structure engaging clamp 5 comprises a substantially c-shaped bracket 7 having a body portion 9 bridging a pair of outwardly projecting arms 11, 13. A fixed clamping head 15 is mounted adjacent the free end of one of the arms 13 and a movable clamping head 17 is mounted on a driving rod 19 which in turn is slidable within a bore in the other arm 11 for movement towards and away from the fixed clamping head 15. A driven ratchet mechanism 21 is provided between the driving rod 19 and the c-shaped bracket 7 for urging the driving rod 19 and hence the movable clamping head 17 towards the fixed clamping head 15 and a quick release locking means 23 is provided to allow disengagement of the driven ratchet mechanism 21 and hence disengagement of the movable clamping head 17.

The driven ratchet mechanism 21 comprises a driving plate 25 having a through bore (not shown) for reception of the driving rod 19. The through bore is marginally larger in circumference than the driving rod 19 so that the driving plate 25 is able to tilt relative the driving rod 19 to and from a driving configuration and a release configuration. A trigger 27 is pivotally mounted intermediate its ends about pivot point 29 on the structure engaging clamp. One end of the trigger is held in engagement with the driving plate 25. A resilient biasing member, provided by way of helical spring 31 urges the driving plate to a position substantially orthogonal to the driving rod 19. There is additionally provided a handle 28 connected to the c-shaped bracket to be gripped by the user.

The quick release locking means 23 comprises a locking plate 33 having a through bore 35 for engagement of the driving rod. The through bore 35 is marginally larger in circumference than the driving rod 19 so that the locking plate is tiltable relative the driving rod to and from a locking configuration in which the locking plate is offset from the orthogonal to the main axis of the driving rod and a release configuration in which the locking plate is substantially orthogonal to the main axis of the driving rod 19. A resilient biasing member, provided by helical spring 37 is provided to urge the locking plate into a locking configuration.

Finally, the securing clamp 3 comprises a substantially unshaped bracket 39 having a locking member provided by an elongate threaded twist lock 41. A knob 43 is provided for manipulating the threaded twist lock 41 at one end of the threaded twist lock and an abutment 45 is mounted on the other end of the threaded twist lock 41 for engagement of the side of the ladder. The securing clamp is connected to the structure engaging clamp by way of cross bar 47. The securing clamp is rotatably mounted about the cross bar 47 so that it can rotate through 360°.

In use, the operator of the device ascends the ladder and places the structure engaging clamp around the portion of the structure to which it is to be connected. Once the approximate position for the ladder engaging clamp has been determined, the operator secures the securing clamp 3 to the ladder by placing the u-shaped securing bracket 39 around one side of the ladder and then twisting the knob 43 of the threaded twist lock until the abutment 45 comes into contact with the side of the ladder. The knob 43 is twisted until the ladder is securely fastened between the abutment 45 and the unshaped bracket 39. Once the securing clamp has been fastened to the side of the ladder the operator opens the structure engaging clamp to its maximum extension by depressing the locking plate 33 against the spring 37 and pulling the driving rod upwards by a knob 49 attached to the end of the driving rod 19 remote from the fixed clamping head until the fixed clamping head 15 and the movable clamping head 17 are at their maximum separation. The operator then rotates the structure engaging clamp until the portion of the structure upon which the structure engaging clamp is to be connected to lies between the fixed and the movable clamping heads. Once in position, the operator simultaneously grips the handle 28 and the trigger 27 and squeezes the trigger 27 towards the handle 28. This movement of the trigger 27 causes the end of the trigger in contact with the driving plate 25 to push the driving plate downwards. When moved in such a fashion, the driving plate 25 at first will tilt to a driving position in which the driving plate is offset from the orthogonal to the main axis of the driving rod 19. In doing so the driving plate 25 grips the driving rod 19 and further motion of the trigger 27 causes the driving plate and the gripped driving rod to be pushed downwards. This is turn causes the movable clamping head 17 to approach the fixed clamping head 15 thereby securing the portion of the structure therebetween. The trigger 27 may have to be squeezed and released a number of times depending on the distance between the fixed and movable clamping heads 15, 17 and the size of the portion to which the clamp is being connected to.

The quick release locking means 23 is such that the locking plate 33 permits movement of the driving rod in the direction towards the fixed clamping head 15. Movement in the opposite direction however is prevented by the locking plate which is urged into a locking configuration by the spring 37. When the driving rod is urged in the direction of the fixed clamping head by the driven ratchet mechanism, the driving rod 19 acts against the locking plate 33 and hence the spring 37 and pushes the locking plate marginally downwards so that the driving rod is allowed to pass through the locking plate. Any attempt at movement of the driving rod 19 in the direction away from the fixed clamping head 15 however will cause the locking plate to be pushed upwards into a locking configuration thereby tightening the grip of the locking plate on the driving rod 19 thereby preventing movement of the driving rod in that direction. In order to disengage the driven ratchet mechanism and hence the movable clamping head 17 so that the ladder clamp may be removed from the structure, all the operator has to do is to urge the locking plate 33 downwards against the spring 37 with their thumb or finger so that the locking plate is substantially orthogonal to the main axis of the driving rod. In this configuration the driving rod 19 may be pulled upwards by knob 49 thereby separating the fixed and movable clamping heads and allowing the ladder clamp to be removed from the structure to which it has been attached.

Referring to FIG. 4 of the drawings there is shown an alternative construction of ladder clamp according to the invention where like parts have been given the same reference numerals as before. The ladder clamp further comprises a second securing clamp 51 mounted on the opposite side of the c-shaped bracket to the first securing clamp 3. The second securing clamp is also provided with a threaded twist lock 53 having a knob 55 mounted on one end thereof and an abutment (not shown) mounted on the other end thereof for engagement of the side of a ladder. In this way, the ladder clamp may be easily fitted onto either side of the ladder depending on which is desirable to the user.

Referring to FIG. 5 of the drawings there is shown another alternative construction of ladder clamp according to the invention where like parts have been given the same reference numerals as before. The ladder clamp further comprises a pair of stabilizing struts 65, 67, mounted on the c-shaped bracket, each of which protrudes outwardly from the c-shaped bracket in substantially the same direction as one of the pair of securing clamps 3, 51. The stabilizing struts 65, 67 are arranged to protrude outwardly from the c-shaped bracket by substantially the same distance as the cross bar 47 so that when the securing clamp is fastened to a ladder the stabilizing strut on the same side of the c-shaped bracket as the securing clamp connected to the ladder abuts against the outer face of the side of the ladder upon which the securing clamp is mounted. In this way, the ladder clamp will be further stabilized against any sideways movement.

Referring to FIG. 6 of the drawings there is shown an enlarged view of the movable clamping head 17. The clamping head is pivotally mounted on the driving rod 19, only part of which is shown for reasons of clarity. The movable clamping head 17 is allowed to pivot about cross bar 59. Preferably the entire clamping head is constructed from a non-slip substance such as rubber. It is envisaged however that only a structure engaging face 61 could be covered in a non-slip material. Furthermore, it is envisaged that the fixed clamping head could be pivotally mounted in the same manner.

Referring to FIGS. 7 and 8 of the drawings, there are shown a pair of views in which the ladder clamp as shown in FIGS. 1 to 3 is shown in operation attached to both a ladder and a portion of a structure with the ladder shown in ghost for reasons of clarity. Referring specifically to FIG. 7 of the drawings, the ladder clamp is shown attached to both a ladder 71 and a concrete window sill 73 formed on the side wall 75 of a building. The ladder clamp 1 secures the ladder 71 in position relative the window sill 73 and sideways slippage of the ladder is obviated. Referring specifically to FIG. 8 there is shown a ladder clamp 1 attached to both a ladder 71 and a fascia board 81 of a roof 83 of a building 85. Again, by securing the ladder to the fascia board in this manner the ladder will not be prone to slipping sideways. Furthermore, it can be seen that the ladder clamp may be connected to a variety of different structures including gutters, parapet walls, window sills, fascia boards and other such structures. It can be seen that the structure engaging clamp 5 shown in FIG. 8 is rotated by 90° with respect to the orientation of the structure engaging clamp 5 shown in FIG. 7. The ladder clamp 1 is constructed so that the securing clamp and the structure engaging clamp are rotatable with respect to each other, therefore the clamp may be used to clamp onto a variety of different structures in a variety of different orientations making the ladder clamp flexible in its application.

In this specification the terms “comprise, comprises, comprised and comprising” and the terms “include, includes, included and including” are deemed totally interchangeable and should be afforded the widest possible interpretation.

This invention is in no way limited to the embodiments hereinbefore described but may be varied in both construction and detail within the scope of the claims.

1-18. (canceled)

19) A ladder clamp (1) comprising a securing clamp (3) for mounting fast on a ladder and a structure engaging clamp (5) connected to the securing clamp for securing the ladder clamp to a portion of a structure, the structure engaging clamp comprises:
a substantially c-shaped bracket (7) having a body portion (9) bridging a pair of outwardly projecting arms (11, 13);
a fixed clamping head (15) mounted adjacent the free end of one of the arms (13);
a movable clamping head (17) mounted on a driving rod (19), the driving rod being slidable within a bore in the other arm (11) for movement towards and away from the fixed clamping head (15);
a driven ratchet mechanism (21) between the driving rod and the c-shaped bracket (7) for urging the driving rod (19) and hence the movable clamping head (17) towards the fixed clamping head (15) for engagement of a structure therebetween; and
a quick release locking mechanism (23) to allow disengagement of the ratchet and hence disengagement of the movable clamping head (17).

20) A ladder clamp (1) as claimed in claim 19 in which the quick release locking mechanism (23) further comprises a locking plate (33) having a through bore (35) for reception of the driving rod (19), the locking plate (33) being tiltable relative the driving rod to and from a locking configuration and a release configuration and a resilient biasing member (37) for urging the locking plate (33) into a locking configuration.

21) A ladder clamp (1) as claimed in claim 19 in which the driven ratchet mechanism (21) further comprises a driving plate (25) having a through bore for reception of the driving rod (19), and a trigger (27) pivotally mounted intermediate its ends on the structure engaging clamp (5), one end of the trigger being in engagement with the driving plate (25), the driving plate being tiltable to and from a driving configuration in which the driving plate grips the driving rod and causes the driving rod to move towards the fixed clamping head and a release configuration in which the driving plate is able to move relative the driving rod, the driving plate being tiltable on actuation of the trigger.

22) A ladder clamp (1) as claimed in claim 21 in which there is provided a resilient biasing member (31) acting on the driving plate (25), urging the driving plate into a release configuration.

23) A ladder clamp (1) as claimed in claim 19 in which there are provided a pair of securing clamps (3) connected to the structure engaging clamp (5), one of the securing clamps being located on one side of the structure engaging clamp (5) and the other securing clamp being located on the other side of the structure engaging clamp.

24) A ladder clamp (1) as claimed in claim 19 in which the securing clamp (3) is rotatably mounted with respect to the structure engaging clamp (5).

25) A ladder clamp (1) as claimed in claim 19 in which the securing clamp (3) further comprises a substantially U-shaped bracket (39) having a locking member for securing the securing clamp (3) to the ladder.

26) A ladder clamp (1) as claimed in claim 25 in which the locking member further comprises a twist screw (41) for bearing against a side of the ladder.

27) A ladder clamp (1) as claimed in claim 25 in which the locking member further comprises a strap connected at one end to the ladder clamp (1) and its other end being securable in a strap fastener mounted on the securing clamp.

28) A ladder clamp (1) as claimed in claim 19 in which the movable clamping head (17) is pivotally mounted on the driving rod.

29) A ladder clamp (1) as clamed in claim 19 in which the fixed clamping head (15) is pivotally mounted on the arm (13).

30) A ladder clamp (1) as claimed in claim 19 in which the clamping heads are provided with a non-slip coating.

31) A ladder clamp (1) as claimed in claim 19 in which the clamping heads (15,17) are substantially arcuate in cross-section, the open mouth of each of the clamping heads facing the open mouth of the other clamping head.

32) A ladder clamp (1) as claimed in claim 19 in which the clamping heads (15, 17) are substantially semi-circular in cross-section.

33) A ladder clamp (1) as claimed in claim 19 in which at least one of the clamping heads is substantially L-shaped in cross-section.

34) A ladder clamp (1) as claimed in claim 19 in which there is provided at least one stabilizing strut protruding outwardly from the C-shaped bracket in substantially the same direction as the securing clamp (3) for engaging the outer face of the side of the ladder upon which the ladder clamp is mounted.

35) A ladder clamp (1) comprising a securing clamp (3) for mounting fast on a ladder and a structure engaging clamp (5) connected to the securing clamp for securing the ladder clamp to a portion of a structure, the structure engaging clamp comprises:
a substantially c-shaped bracket (7) having a body portion (9) bridging a pair of outwardly projecting arms (11, 13);
a fixed clamping head (15) mounted adjacent the free end of one of the arms (13);
a movable clamping head (17) mounted on a driving rod (19), the driving rod being slidable within a bore in the other arm (11) for movement towards and away from the fixed clamping head (15);
a driven ratchet mechanism (21) between the driving rod and the c-shaped bracket (7) for urging the driving rod (19) and hence the movable clamping head (17) towards the fixed clamping head (15) for engagement of a structure therebetween; and
a quick release locking mechanism (23) to allow disengagement of the ratchet and hence disengagement of the movable clamping head (17),
the quick release locking mechanism (23) further comprises a locking plate (33) having a through bore (35) for reception of the driving rod (19), the locking plate (33) being tiltable relative the driving rod to and from a locking configuration and a release configuration and a resilient biasing member (37) for urging the locking plate (33) into a locking configuration.

36) A ladder clamp (1) as claimed in claim 35 in which the driven ratchet mechanism (21) further comprises a driving plate (25) having a through bore for reception of the driving rod (19), and a trigger (27) pivotally mounted intermediate its ends on the structure engaging clamp (5), one end of the trigger being in engagement with the driving plate (25), the driving plate being tiltable to and from a driving configuration in which the driving plate grips the driving rod and causes the driving rod to move towards the fixed clamping head and a release configuration in which the driving plate is able to move relative the driving rod, the driving plate being tiltable on actuation of the trigger.

37) A ladder clamp (1) as claimed in claim 36 in which there is provided a resilient biasing member (31) acting on the driving plate (25), urging the driving plate into a release configuration.

38) A ladder clamp (1) as claimed in claim 35 in which there are provided a pair of securing clamps (3) connected to the structure engaging clamp (5), one of the securing clamps being located on one side of the structure engaging clamp (5) and the other securing clamp being located on the other side of the structure engaging clamp.

39) A ladder clamp (1) as claimed in claim 35 in which the securing clamp (3) is rotatably mounted with respect to the structure engaging clamp (5).

40) A ladder clamp (1) as claimed in claim 35 in which the securing clamp (3) further comprises a substantially U-shaped bracket (39) having a locking member for securing the securing clamp (3) to the ladder.

41) A ladder clamp (1) as claimed in claim 40 in which the locking member further comprises a twist screw (41) for bearing against a side of the ladder.

42) A ladder clamp (1) as claimed in claim 35 in which the movable clamping head (17) is pivotally mounted on the driving rod.

43) A ladder clamp (1) as clamed in claim 35 in which the fixed clamping head (15) is pivotally mounted on the arm (13).

44) A ladder clamp (1) comprising a securing clamp (3) for mounting fast on a ladder and a structure engaging clamp (5) connected to the securing clamp for securing the ladder clamp to a portion of a structure, the structure engaging clamp comprises:
a substantially c-shaped bracket (7) having a body portion (9) bridging a pair of outwardly projecting arms (11, 13);
a fixed clamping head (15) mounted adjacent the free end of one of the arms (13);
a movable clamping head (17) mounted on a driving rod (19), the driving rod being slidable within a bore in the other arm (11) for movement towards and away from the fixed clamping head (15);
a driven ratchet mechanism (21) between the driving rod and the c-shaped bracket (7) for urging the driving rod (19) and hence the movable clamping head (17) towards the fixed clamping head (15) for engagement of a structure therebetween, the driven ratchet mechanism (21) further comprises a driving plate (25) having a through bore for reception of the driving rod (19), and a trigger (27) pivotally mounted intermediate its ends on the structure engaging clamp (5), one end of the trigger being in engagement with the driving plate (25), the driving plate being tiltable to and from a driving configuration in which the driving plate grips the driving rod and causes the driving rod to move towards the fixed clamping head and a release configuration in which the driving plate is able to move relative the driving rod, the driving plate being tiltable on actuation of the trigger; and
a quick release locking mechanism (23) to allow disengagement of the ratchet and hence disengagement of the movable clamping head (17);

45) A ladder clamp (1) as claimed in claim 44 in which the quick release locking mechanism (23) further comprises a locking plate (33) having a through bore (35) for reception of the driving rod (19), the locking plate (33) being tiltable relative the driving rod to and from a locking configuration and a release configuration and a resilient biasing member (37) for urging the locking plate (33) into a locking configuration.

46) A ladder clamp (1) as claimed in claim 44 in which there is provided a resilient biasing member (31) acting on the driving plate (25), urging the driving plate into a release configuration.

47) A ladder clamp (1) as claimed in claim 44 in which there are provided a pair of securing clamps (3) connected to the structure engaging clamp (5), one of the securing clamps being located on one side of the structure engaging clamp (5) and the other securing clamp being located on the other side of the structure engaging clamp.

48) A ladder clamp (1) as claimed in claim 44 in which the securing clamp (3) is rotatably mounted with respect to the structure engaging clamp (5).

49) A ladder clamp (1) as claimed in claim 44 in which the securing clamp (3) further comprises a substantially U-shaped bracket (39) having a locking member for securing the securing clamp (3) to the ladder.

50) A ladder clamp (1) as claimed in claim 49 in which the locking member further comprises a twist screw (41) for bearing against a side of the ladder.

51) A ladder clamp (1) as claimed in claim 44 in which the clamping heads (15, 17) are pivotally mounted on the driving rod and the arm (13) respectively.

52) A ladder clamp (1) comprising a securing clamp (3) for mounting fast on a ladder and a structure engaging clamp (5) connected to the securing clamp for securing the ladder clamp to a portion of a structure, the securing clamp (3) being rotatably mounted with respect to the structure engaging clamp (5), the structure engaging clamp comprises:
a substantially c-shaped bracket (7) having a body portion (9) bridging a pair of outwardly projecting arms (11, 13);
a fixed clamping head (15) mounted adjacent the free end of one of the arms (13);
a movable clamping head (17) mounted on a driving rod (19), the driving rod being slidable within a bore in the other arm (11) for movement towards and away from the fixed clamping head (15);
a driven ratchet mechanism (21) between the driving rod and the c-shaped bracket (7) for urging the driving rod (19) and hence the movable clamping head (17) towards the fixed clamping head (15) for engagement of a structure therebetween;
a quick release locking mechanism (23) to allow disengagement of the ratchet and hence disengagement of the movable clamping head (17).

53) A ladder clamp (1) as claimed in claim 52 in which the quick release locking mechanism (23) further comprises a locking plate (33) having a through bore (35) for reception of the driving rod (19), the locking plate (33) being tiltable relative the driving rod to and from a locking configuration and a release configuration and a resilient biasing member (37) for urging the locking plate (33) into a locking configuration.

54) A ladder clamp (1) as claimed in claim 52 in which the driven ratchet mechanism (21) further comprises a driving plate (25) having a through bore for reception of the driving rod (19), and a trigger (27) pivotally mounted intermediate its ends on the structure engaging clamp (5), one end of the trigger being in engagement with the driving plate (25), the driving plate being tiltable to and from a driving configuration in which the driving plate grips the driving rod and causes the driving rod to move towards the fixed clamping head and a release configuration in which the driving plate is able to move relative the driving rod, the driving plate being tiltable on actuation of the trigger.

55) A ladder clamp (1) as claimed in claim 54 in which there is provided a resilient biasing member (31) acting on the driving plate (25), urging the driving plate into a release configuration.

56) A ladder clamp (1) as claimed in claim 52 in which there are provided a pair of securing clamps (3) connected to the structure engaging clamp (5), one of the securing clamps being located on one side of the structure engaging clamp (5) and the other securing clamp being located on the other side of the structure engaging clamp.

57) A ladder clamp (1) as claimed in claim 52 in which the securing clamp (3) further comprises a substantially U-shaped bracket (39) having a locking member for securing the securing clamp (3) to the ladder.

58) A ladder clamp (1) as claimed in claim 57 in which the locking member further comprises a twist screw (41) for bearing against a side of the ladder.

59) A ladder clamp (1) as claimed in claim 52 in which the clamping heads (15, 17) are pivotally mounted on the driving rod and the arm (13) respectively.

60) A ladder clamp (1) comprising a securing clamp (3) for mounting fast on a ladder and a structure engaging clamp (5) connected to the securing clamp for securing the ladder clamp to a portion of a structure, the structure engaging clamp comprises:
a substantially c-shaped bracket (7) having a body portion (9) bridging a pair of outwardly projecting arms (11, 13);
a fixed clamping head (15) mounted adjacent the free end of one of the arms (13);
a movable clamping head (17) mounted on a driving rod (19), the driving rod being slidable within a bore in the other arm (11) for movement towards and away from the fixed clamping head (15);
a driven ratchet mechanism (21) between the driving rod and the c-shaped bracket (7) for urging the driving rod (19) and hence the movable clamping head (17) towards the fixed clamping head (15) for engagement of a structure therebetween;
a quick release locking mechanism (23) to allow disengagement of the ratchet and hence disengagement of the movable clamping head (17); and
the securing clamp (3) further comprises a substantially U-shaped bracket (39) having a locking member for securing the securing clamp (3) to the ladder.

61) A ladder clamp (1) as claimed in claim 60 in which the quick release locking mechanism (23) further comprises a locking plate (33) having a through bore (35) for reception of the driving rod (19), the locking plate (33) being tiltable relative the driving rod to and from a locking configuration and a release configuration and a resilient biasing member (37) for urging the locking plate (33) into a locking configuration.

62) A ladder clamp (1) as claimed in claim 60 in which the driven ratchet mechanism (21) further comprises a driving plate (25) having a through bore for reception of the driving rod (19), and a trigger (27) pivotally mounted intermediate its ends on the structure engaging clamp (5), one end of the trigger being in engagement with the driving plate (25), the driving plate being tiltable to and from a driving configuration in which the driving plate grips the driving rod and causes the driving rod to move towards the fixed clamping head and a release configuration in which the driving plate is able to move relative the driving rod, the driving plate being tiltable on actuation of the trigger.

63) A ladder clamp (1) as claimed in claim 62 in which there is provided a resilient biasing member (31) acting on the driving plate (25), urging the driving plate into a release configuration.

64) A ladder clamp (1) as claimed in claim 60 in which there are provided a pair of securing clamps (3) connected to the structure engaging clamp (5), one of the securing clamps being located on one side of the structure engaging clamp (5) and the other securing clamp being located on the other side of the structure engaging clamp.

65) A ladder clamp (1) as claimed in claim 60 in which the securing clamp (3) is rotatably mounted with respect to the structure engaging clamp (5).

66) A ladder clamp (1) as claimed in claim 60 in which the locking member further comprises a twist screw (41) for bearing against a side of the ladder.

67) A ladder clamp (1) as claimed in claim 60 in which the clamping heads (15, 17) are pivotally mounted on the driving rod and the arm (13) respectively.
